(19) United States
(12) Patent Application Publication
(10) Pub. No.: US 2007/0146886 A1
(43) Pub. Date: Jun. 28, 2007

(54) Unitary optical element providing wavelength selection

(75) Inventors: Alejandro D. Farinas, Mountain View, CA (US); Douglas Reid, Hillmorton Rugby (GB)

Correspondence Address: MORRISON & FOERSTER LLP, 425 MARKET STREET, SAN FRANCISCO, CA, 94105-2482, US

(73) Assignee: Bookham Technology plc, Towcester (GB)

(21) Appl. No.: 11/584,394

(22) Filed: Oct. 19, 2006

Related U.S. Application Data
(60) Provisional application No. 60/752,937, filed on Dec. 21, 2005.

(51) Int. Cl. G02B 5/18

(52) U.S. Cl. 359/572

(57) ABSTRACT

An apparatus and method for integrated grating feedback and retro-reflection are disclosed herein. An unitary optical element is designed to provide a feedback output at one end and an ancillary output at an opposite end. A desired output wavelength is determined by the geometry and index of refraction of the unitary optical element.

### CROSS-REFERENCE TO RELATED APPLICATIONS

The present application claims priority to U.S. Provisional Application No. 60/752,937, filed Dec. 21, 2005, entitled “UNITARY OPTICAL ELEMENT PROVIDING WAVELENGTH SELECTION,” the content of which is incorporated herein by reference in its entirety.

### BACKGROUND OF THE INVENTION

The present invention relates to laser systems. More particularly, the present invention relates to an optical component for laser systems.

A laser beam having a particular wavelength can be obtained at the output of a laser cavity or at the output of an optical element provided external to the laser cavity. When a wavelength is desired at the laser output, but the gain element inside the laser cavity lases at a wavelength different from the desired wavelength, then an extended cavity configuration can be utilized to achieve the desired wavelength as the laser output. In particular, an intracavity diffraction grating may be utilized to tune the laser cavity to output the desired wavelength laser beam. Examples of extended cavity diffraction grating configurations include the Littrow configuration and the Littman-Metcalf configuration.

For the Littrow configuration, a laser cavity may be formed by a diode laser acting as the gain element, a diffraction grating, and a collimating optical element provided between the diode laser and the diffraction grating (also referred to as an extended cavity diode laser (ECDL) Littrow configuration). The output of the diode laser is collimated and then impinges on the diffraction grating. The diffraction grating spectrally diffracts the impinging light. The diffraction grating is oriented relative to the diode laser so as to have the component of the spectral diffraction at the desired wavelength reflect back toward the diode laser. This forms the optical feedback to generate a laser beam output at the desired wavelength.

Although the diffraction grating permits the extended cavity to be tuned to a number of different wavelengths (e.g., by changing the orientation of the diffraction grating relative to the diode laser), such flexibility also creates critical alignment issues for Littrow configurations. Properly tuning the cavity to a desired wavelength requires isolating a particular spectral diffraction component and establishing an optical feedback with the diode laser. However, the angular separation between the different spectral diffraction components is small. This translates to critical alignment tolerances and marginal side mode suppression. Also, precise alignment of the diffraction grating is required to reflect the desired diffracted light back into the gain medium associated with the diode laser. This critical alignment of the diffraction grating in two directions is time-consuming and can lead to low manufacturing yield.

An alternative to the Littrow configuration is the Littman-Metcalf configuration. With the Littman-Metcalf configuration, the ECDL includes a reflective optical element adjacent to the diffraction grating. The output of the diode laser is diffracted by a diffraction grating, and the reflection optical element (e.g. a mirror) is oriented to reflect a particular spectral diffraction component from the diffraction grating back to the diode laser. An optical feedback is thus established using the particular spectral diffraction component between the diode laser and the reflective optical element.

Although the Littman-Metcalf configuration addresses some of the shortcomings of the Littrow configuration, both configurations are difficult to tune. Initially aligning the components within the extended cavity to lase at a desired wavelength, maintaining the alignment over different handling and operating conditions, and re-aligning over time as component orientations drift over time are all issues with the Littman-Metcalf and Littrow configurations.

Thus, it would be beneficial for an extended cavity laser system to be easily tunable to at least one pre-selected wavelength. It would also be beneficial for an extended cavity system to be configured from a minimal number of optical elements to provide ease in alignment. It would further be beneficial for a single optical element to provide multiple functionalities and have minimal alignment requirements. It would also be beneficial for an optical element to have a large alignment tolerance within an extended cavity system. It would be further beneficial for the optical element to be an integrated optical filter.

### BRIEF SUMMARY OF THE INVENTION

One embodiment of the invention relates to a monolithic optical element. The monolithic optical element includes a diffraction grating, a reflecting surface disposed opposite the diffraction grating, and a first light transmissive surface disposed adjacent to the diffraction grating. The first light transmissive surface is operable to direct external light incident thereon from a first direction and internally direct toward the diffraction grating. The diffraction grating is operable to generate a first component of the directed light and internally direct the first component toward the reflecting surface. The reflecting surface is operable to reflect the first component internally toward the diffraction grating. The diffraction grating is operable to direct the reflected first component internally toward the first light transmissive surface. The first light transmissive surface is operable to direct at least a portion of the reflected first component in a direction substantially opposite to the first direction and external to the monolithic optical element.

Another embodiment of the invention relates to a monolithic optical element. The monolithic optical element includes a diffraction grating, a first light transmissive surface disposed adjacent to the diffraction grating, and a second light transmissive surface disposed adjacent to the diffraction grating and opposite to the first light transmissive surface. The first light transmissive surface is operable to direct external light incident thereon from a first direction, and internally direct toward the diffraction grating. The diffraction grating is operable to generate a first component of the directed light and internally direct the first component toward the second light transmissive surface. The second light transmissive surface is operable to direct at least a portion of the first component in substantially a same direction as the first direction and external to the monolithic optical element.

Still another embodiment of the invention relates to an extended cavity laser system. The system includes a gain medium outputting a light beam, and a unitary optical element disposed adjacent to the gain medium. The unitary optical element includes a diffraction grating, a reflecting surface disposed opposite to the diffraction grating, a first light transmissive surface disposed adjacent to the diffraction grating, and a second light transmissive surface disposed adjacent to the diffraction grating and opposite to the first light transmissive surface. The first light transmissive surface is operable to accept the light beam and internally direct the accepted light beam toward the diffraction grating. The diffraction grating is operable to generate a first component of the accepted light beam and internally direct the first component toward the reflecting surface. The diffraction grating is also operable to generate a second component of the accepted light beam and internally direct the second component toward the second light transmissive surface. The reflecting surface is operable to reflect the first component internally toward the diffraction grating. The diffraction grating is operable to direct the reflected first component internally toward the first light transmissive surface. The first light transmissive surface is operable to direct the reflected first component external to the unitary optical element and toward the gain medium. The second light transmissive surface is operable to direct the second component external to the unitary optical element. A feedback light is formed from the reflected first component directed toward the gain medium and the light beam. A light output of the system is at least one of the second component and the feedback light.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### BRIEF DESCRIPTION OF THE DRAWINGS

The exemplary embodiments will become more fully understood from the following detailed description, taken in conjunction with the accompanying drawing, wherein the reference numeral denote similar elements, in which:

FIG. 1 is a front view of one embodiment of an integrated grating feedback and retro-reflector element.

FIG. 2 is a side view of the element of FIG. 1.

FIG. 3 is the element of FIG. 1 implemented in one embodiment of a single-ended extended laser cavity.

FIG. 4 is the element of FIG. 1 implemented in one embodiment of a double-ended extended laser cavity.

FIGS. 5A, 5B, and 5C are side views of another embodiment of the element of FIG. 1.

FIG. 6 illustrates one embodiment of a fabrication technique of the element.

FIGS. 7-11 are perspective views of a material undergoing the fabrication technique of FIG. 6.

In the drawings, to easily identify the discussion of any particular element or part, the most significant digit or digits in a referenced number refer to the figure number in which that element is first introduced (e.g., element 609 is first introduced and discussed with respect to FIG. 6).

### DETAILED DESCRIPTION OF THE PREFERRED EMBODIMENTS

Described in detail below is an apparatus and method for configuring an extended cavity laser to lase at a pre-selected wavelength. An optical element provides integrated spectral diffraction feedback and retro-reflection. The integrated optical element is configured to be an optical feedback element. The design parameters of the integrated optical element are flexible to specify a desired output wavelength. The optical element can alternatively be implemented as an optical filter. The unitary construction of the optical element eliminates the need for sub-elements, or having to align each of such sub-elements relative to each other or a gain medium.

The following description provides specific details for a thorough understanding of, and enabling description for, embodiments of the invention. However, one skilled in the art will understand that the invention may be practiced without these details. In other instances, well-known structures and functions have not been shown or described in detail to avoid unnecessarily obscuring the description of the embodiments of the invention.

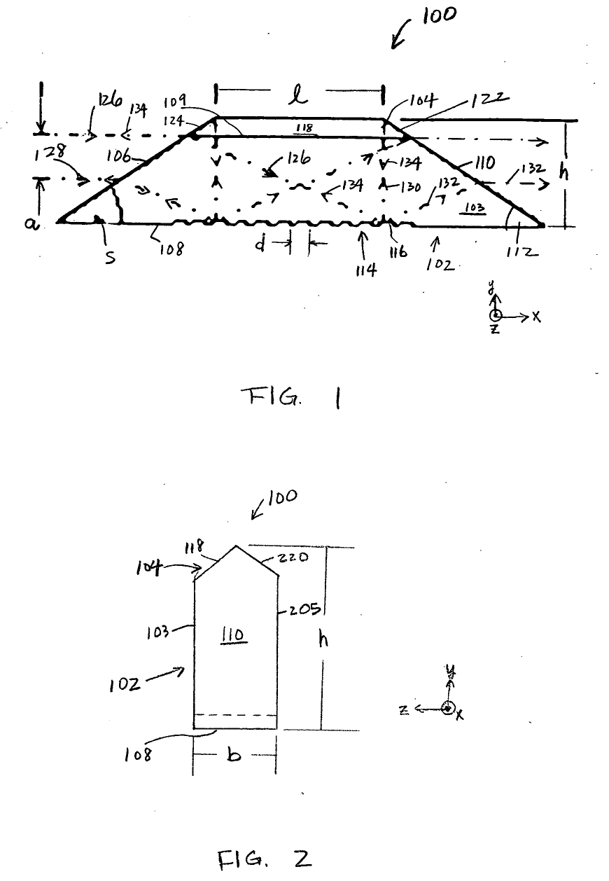

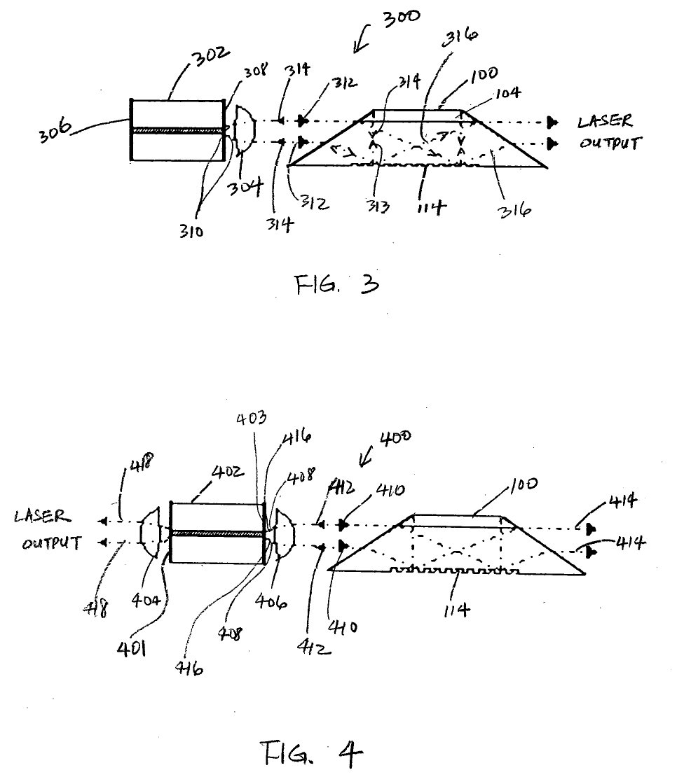

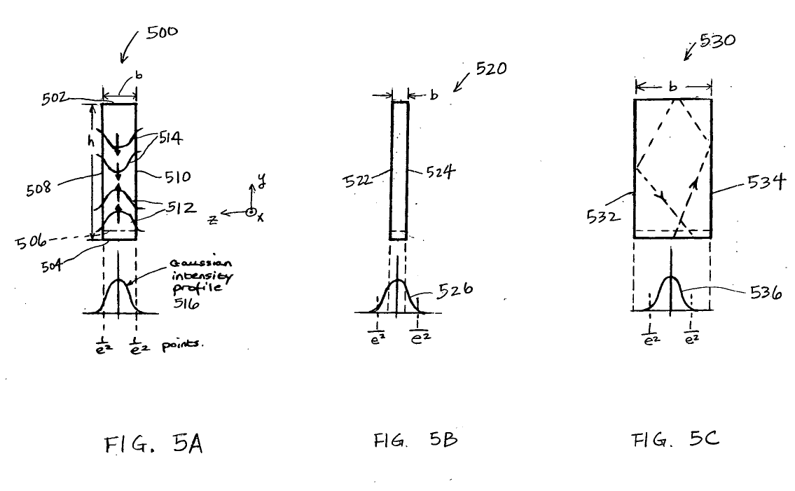

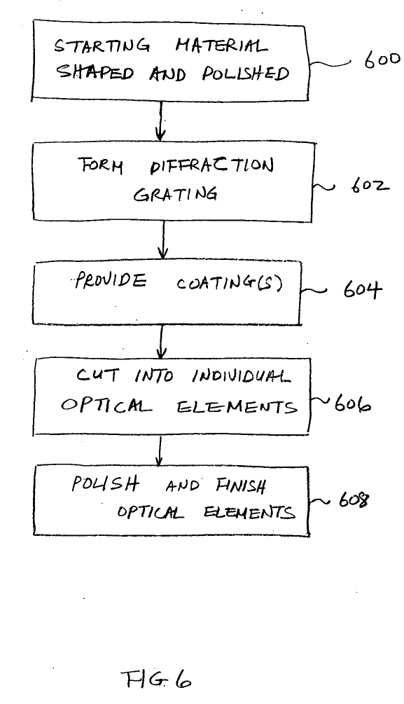

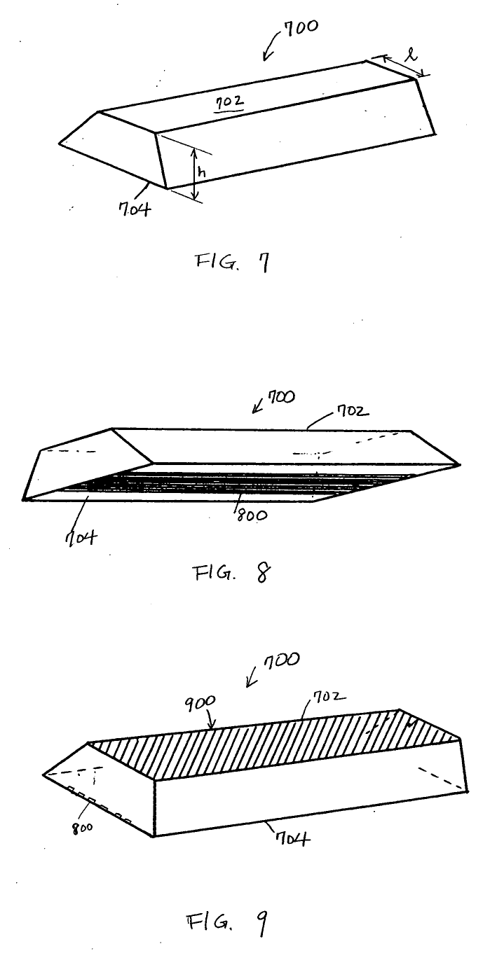

Referring to FIG. 1, a front view of one embodiment of an optical element 100 is shown. The optical element 100, also referred to as a monolithic (or integrated or unitary) diffraction grating and retro-reflector, includes a bottom portion 102 and a top portion 104.

The bottom portion 102 comprises a six-sided solid defined by a pair of parallel quadrilateral faces, a pair of parallel rectangular top and bottom, and a pair of rectangular sides. The shape of the bottom portion 102 is also referred to as a trapezoidal prismoid. The pair of parallel quadrilateral faces are shaped identical to each other. In one embodiment, a front face 103 of the bottom portion 102 is illustrated in FIG. 1 as a trapezoidal shape. The front face 103 and a back face 205 are substantially parallel or parallel to each other (as illustrated in a side view of the optical element 100 in FIG. 2).

The pair of rectangular sides (a first side or face 106 and a second side or face 110) is not parallel to each other. The first and second sides 106, 110 are inclined at certain angles, as defined by their respective intersection with a bottom 108. The first side 106 is inclined at an angle s with respect to the bottom 108. The second side 110 is inclined at an angle 112 with respect to the bottom 108. The first side 106 includes a first light transmissive surface. The second side 110 includes a second light transmissive surface.

The pair of parallel rectangular top and bottom (a top 109 and the bottom 108) defines the remaining sides of the bottom portion 102. The bottom 108 includes a diffraction grating 114. The diffraction grating 114 comprises a set of grooves or indentations fabricated, by etching for example, into the bottom 108. The diffraction grating 114 can comprise a variety of periodic patterns, near-periodic patterns, two or more different shaped indentations within a pattern, or different depth of indentations with a pattern. In FIGS. 1-2, the diffraction grating 114 is a periodic rectangle pattern. Alternatively, the shape can be a sinusoidal, a sawtooth, or a variety of other shapes, limited only by fabrication techniques and/or desired diffractive properties. For example, different shapes or depths of the grooves can result in different portions of the input light being diffracted into the zero and first diffraction orders, which can be used to optimize the output power or stability of the extended cavity laser.

Optionally, the diffraction grating 114 may be coated with an optical coating 116. The optical coating 116 provides greater efficiency to the diffraction grating 114. As examples, the optical coating 116 can comprise a metal coating or a multi-layer dielectric coating.

The top 109 of the bottom portion 102 is a phantom construct, made for purposes of describing the optical element 100. The bottom and top portions 102, 104 together comprise a single piece of optical material. The optical element 100 is also referred to as a monolithic or unitary optical element. Referring to FIG. 2, the top portion 104 comprises sides 118 and 220 that tapers to a vertex. Sides 122 and 124 of the top portion 104 (as shown in FIG. 1) continue the same sloping sides (e.g., sides 106, 110) as the bottom portion 102. The top portion 104 is also referred to as a roof prism.

The optical element 100 is comprised of a material that is optically transparent at the input light's wavelength. The material further possesses an index of refraction (n) suitable for proper function of the optical element (to be explained in detail below). For input light wavelengths approximately in the visible or infrared (IR) range, dielectric materials such as glass, non-linear optical materials such as quartz, electro-optic materials such as lithium niobate, or semiconductor materials such as silicon are suitable. It is contemplated that the optical element 100 can be fabricated from a variety of other materials, as new materials become available and as appropriate relative to the input wavelength.

The diffraction grating 114 can be fabricated using electron beam, holographic, or lithographic techniques. In one embodiment, the diffraction grating 114 is etched into the bottom 108 of the optical element 100. Then an optional coating 116 may be provided over the diffraction grating 114. The optional coating 116 may comprise metallic materials, such as silver, gold, or aluminum, or multi-layer dielectric materials. In FIG. 1, the diffraction grating 114 is shown having a distance or periodicity d. However, the diffraction grating 114 may have a spatially varying periodicity (e.g., a non-constant periodicity) to, for example, shape the optical beam.

Referring to FIGS. 1-2, the distance (or periodicity) d defines a periodic distance of the pattern of the diffraction grating 114. A thickness or depth of the optical element 100 is defined by a thickness (or depth) b. A length of the top portion 104 along its highest point is denoted as a length l. The length of the diffraction grating 114 is at least the same length as the length l. A height of the optical element 100 is denoted as a height h. The angle s defines an angle made by the side 106 and the bottom 108. The angle s is also referred to as the input face angle and the angle 112 is also referred to as the output face angle when an input beam enters the optical element 100 via the first side 106.

The location or position at which a first input ray 126 enters the optical element 100 can be referred to as a maximum input height. The location or position at which a second input ray 128 enters the optical element 100 can be referred to as a minimum input height. The separation distance between the maximum and minimum input heights represents a distance a. For an input beam to be appropriately filtered by the optical element 100 (e.g., appropriately diffracted, reflected, and outputted as described in detail below), the input beam enters the optical element 100 within (or at) the maximum and minimum heights. In other words, the distance a represents the range of input positions or input spot size for the optical element 100. The entry position of the first input ray 126 corresponds to the rightmost incident location possible on the diffraction grating 114. The entry position of the second input ray 128 corresponds to the leftmost incident location possible on the diffraction grating 114. The distance a is also referred to as a virtual input aperture for light inputted at the first side 106.

In the embodiment illustrated in FIG. 1, each of the angles s and 112 is at the Brewster's angle (i.e. the angle at which there is 100% transmission for p-polarized light). The optical element 100 is symmetrical, and either of the first or second sides 106, 110 can serve as the input side and provide identical functionality. As a matter of convention, the first side 106 (i.e., the left side of the optical element 100) will be considered to be the input side or surface.

Light incident on the first side 106 (anywhere within the distance range a) propagates internally within the optical element 100 and is spectrally diffracted by the diffraction grating 114. A first order spectral diffraction component of the incident light is generated by the diffraction grating 114. The first order component is reflected by the top portion 104, is diffracted again by the diffraction grating 114, and exits the optical element 100 via the first side 106. Simultaneously, a zero order spectral diffraction component of the incident light, also generated by the diffraction grating 114, exits the optical element 100 via the second side 110.

Following a beam path illustrated in FIG. 1, the first ray 126 enters the optical element 100 via the first side 106. The first ray 126 propagates within the optical element 100 until incident on the diffraction grating 114. The diffraction grating 114 may diffract the first ray 126 into a number of different spectral components. For purposes of the functionality of the optical element 100, the first and zero order spectral diffraction components are discussed herein. At a wavelength λ₀, the diffraction grating 114 generates a first order diffraction component 130 that is oriented perpendicular to the plane of the bottom 108. The diffraction grating 114 also generates a zero order diffraction component 132 that is oriented at an oblique angle with respect to the plane of the bottom 108.

The first order diffraction component 130 propagates toward the top portion 104, and the top portion 104 reflects the first order diffraction component 130. A first order reflection 134 traverses at least a substantially parallel beam path relative to the first ray 126 and the first order diffraction component 130, except in the opposite direction. The first order reflection 134 travels in a leftward direction to exit the optical element 100 via the first side 106. Accordingly, the first order diffraction component 130 forms the basis for an optical feedback loop with the first ray 126. Due to efficient coupling into the gain medium, the light beam formed by the feedback loop has a minimum loss at the wavelength λ₀. The wavelength λ₀ of the feedback light output is a function of the periodicity d of the diffraction grating 114 and the angle of incidence of the input light at the diffraction grating 114 (as determined by the input face angle s).

Depending on the diameter of the first ray 126 and the configuration of the top portion 104, the reflections can traverse a parallel or identical beam path as the first ray 126 and the first order diffraction component 130, but in the opposite direction (as illustrated in FIGS. 1, 3, and 4). In other instances, at least a substantially parallel beam path will be traversed for the reflections, this beam path being substantially parallel within approximately ±10 degrees or within approximately ±5 degrees relative to the input beam path.

The zero order diffraction component 132 continues to travel through the optical element 100 (in a rightward direction) and exits the optical element. 100 via the second side 110.

The second ray 128 undergoes similar effects to that of the first ray 126. Zero and first order diffraction components are generated by the diffraction grating 114. The first order diffraction component at the wavelength λ₀ is perpendicular to the plane of the bottom 108, travels to the top portion 104, and is reflected by the top portion 114 to travel back along at least a substantially parallel path, but in the opposite direction, as the second ray 128 and the first order diffraction component. A feedback is established by the first order diffraction component perpendicularly being reflected by the top portion 104, and the zero order diffraction component exits at the second side 110. Of course, however, propagation paths would differ from those of the first ray 126 because the location of incidence at the first side 106 is different. For example, the second ray 128 is incident at a different point on the diffraction grating 114 than the first ray 126, the point at the top portion 104 where the reflection occurs is different, and the zero order diffraction component exits at the second side 110 at a different location than the zero order diffraction component 132.

It should be understood that all other input beams incident at the first side 106 at a height between the locations of the first and second beams 126, 128 are also “filtered” as discussed above.

Perfect alignment of the optical element 100 relative to the laser gain medium maximizes feedback from the external cavity back to the laser gain medium, and accordingly maximizes output power of the extended cavity. However, even with less than perfect alignment between the optical element 100 and the laser gain medium, relative misalignment insensitivity of the optical element 100 provides advantageous operability and ease in use. The optical element 100 eliminates certain alignment issues, such as having to align the first order diffraction component reflector relative to the diffraction grating (for example, as in a Littman-Metcalf cavity). The optical element 100 also alleviates critical alignment issues. Misalignment tolerance in the x-y plane is provided by the optical element 100. Misalignment will cause a slight deviation in the desired wavelength λ₀, denoted as Δλ₀=(d/n)(n²−1)/(n²+1)1Δθ, where Δθ is the angular misalignment in the x-y plane. Misalignment tolerance in the x-z plane is also provided by the optical element 100. The roof prism is configured to direct misaligned rays to the laser gain medium.

The coupling efficiency to the laser gain medium is insensitive to angular misalignment. Angular misalignment relative to the z-axis is addressed by the diffraction grating 114 of the optical element 100. The diffraction grating 114 will ensure that the light rays return to the laser gain medium (although at a wavelength that depends on the degree of angular misalignment). Angular misalignment relative to each of the x-axis and y-axis is addressed by the top portion 104 which converts these angular misalignments into translation errors.

The optical element 100 combines a grating feedback and retro-reflector at a given pre-selected wavelength. The diffraction grating 114 and the top portion 104 need not be aligned to output a desired wavelength. Instead, the desired or pre-selected wavelength determines the dimensions of the optical element 100. In other words, rather than tuning (e.g., aligning) a laser system to isolate (or pick off) a beam component having a desired wavelength, the laser system (or at least the tuning element of the laser system) is specifically preconfigured so that the output of the laser system will be at or near the desired wavelength λ₀.

For input beams substantially parallel to the bottom 108, the optical element 100 comprising a material having an index of refraction n, and desiring a wavelength λ₀ of minimum loss (i.e., continuing the convention, the output at the first side 106), the dimensions or geometry of the optical element 100 are determined according to Equations (1)-(4):

$$\begin{matrix}d = {λ}_{0} ( \frac{{n}^{2} + 1}{2 {n}^{2}} ) & ( 1 ) \\ s = {tan}^{- 1} ( \frac{1}{n} ) & ( 2 ) \\ h = \frac{1}{2} ( a + \frac{b}{2} ) ( {n}^{2} + 1 ) & ( 3 ) \\ l = an ( \frac{{n}^{2} + 1}{{n}^{2} - 1} ) & ( 4 )\end{matrix}$$

Referring to FIG. 3, the optical element 100 is shown implemented in one embodiment of a single-ended laser cavity 300. The single-ended laser cavity 300, also referred to as a single ended extended (or external) laser cavity (or system), comprises a gain medium 302, a collimating lens 304, and the optical element 100. The collimating lens 304 is provided along the beam path between the gain medium 302 and the optical element 100.

The gain medium 302 (also referred to as a gain element) includes a high reflective (HR) coating 306 at one end and an anti-reflective (AR) coating 308 at an opposite end. The end including the AR coating 308 is closer to the collimating lens 304. The gain medium 302 can comprise a variety of gain mediums, including but not limited to, a diode laser, a diode gain element, a semiconductor gain element, or a solid-state gain element. The gain medium 302, either inherently (as in the waveguide in a diode laser) or through an external aperture, provides a spatial filtering function.

The laser system illustrated in FIG. 3 illustrates the use of the right side output (i.e., the zero order diffraction component) of the optical element 100 as the laser output. In this configuration, the optical element 100 functions as a wavelength-dependent mirror and output-coupler, configuring the wavelength of the laser output to be different from the wavelength of the gain medium 302's free-running output.

An output beam 310 of the gain medium 302 is collimated by the collimating lens 304. A collimated beam 312 is the input to the optical element 100. The collimated beam 312 is diffracted into a first order diffraction component 313 and a zero order diffraction component 316. The first order diffraction component 313 at the desired wavelength λ₀ travels perpendicular to the plane of the diffraction grating 114 and is reflected by the top portion 104 into a reflected beam 314. The reflected beam 314 travels back along at least a substantially parallel beam path and returns into the gain medium 302 to form a feedback loop.

The zero order diffraction component 316 is the right side output of the optical element 100. The zero order diffraction component 316 is also referred to as a laser output.

Referring to FIG. 4, the optical element 100 is shown implemented in one embodiment of a double-ended laser cavity 400. The double-ended laser cavity 400, also referred to as a double ended extended (or external) laser cavity (or system), comprises a gain medium 402, a first collimating lens 404, a second collimating lens 406, and the optical element 100. The gain medium 402 is provided between the first and second collimating lenses 404, 406. The second collimating lens 406 is provided between the gain medium 402 and the optical element 100.

The gain medium 402 includes a partially reflecting output-coupler (OC) coating 401 at a side closer to the first collimating lens 404. The gain medium 402 also includes an anti-reflective (AR) coating 403 at a side opposite to the side with the OC coating 402 and closer to the second collimating lens 406. The gain medium 402 can comprise a variety of gain mediums, including but not limited to, a diode laser, a diode gain element, a semiconductor gain element, or a solid-state gain element. The gain medium 402, either inherently (as in the waveguide in a diode laser) or through an external aperture, provides a spatial filtering function. The reflectivity of the OC coating 401 can be selected to maximize the laser system's output power.

For the cavity 400, a laser output 418 is formed utilizing the feedback or left side output of the optical element 100. The laser output 418 has the desired wavelength λ₀. The right side output of the optical element 100 is an auxiliary or unwanted output and is typically not utilized.

An output beam 408 is one of two outputs of the gain medium 402. The output beam 408 is collimated by the second collimating lens 406 into a collimated beam 410. The collimated beam 410 enters the optical element 100. A first order diffraction component 412 is returned along at least a substantially parallel beam path to the input beam path on the left side of the optical element 100. A zero order diffraction component 414 (i.e., the auxiliary or unwanted component) is outputted from the right side of the optical element 100.

The first order diffraction component 412 continues through the second collimating lens 406 and into the gain medium 402. From the first order diffraction component 412 in the gain medium 402, a new oscillation pattern is established within the gain medium 402. The gain medium 402 emits light from both sides, and the laser output 418 is outputted from the opposite side from the output beam 408. The laser output 418 is a collimated beam via the first collimating lens 404.

It is understood that the pair of light beams shown in each of FIGS. 3 and 4 illustrates the range of beam paths and/or beam spot size possible in the cavities 300 and 400, respectively. Each of the output beams 310 and 408 (and the subsequent beams formed from the output beams 310, 408) is a single beam and not two distinct beams traveling in tandem.

Although only a single roundtrip of the feedback loop has been described above, the feedback loop comprises a plurality of roundtrips between the optical element 100 and the gain medium. The system operates at a lasing mode, the mode at which a round-trip phase of a beam is an integral number of 2π, whose wavelength is closest to the filter's center wavelength λ₀, and which will oscillate when its total round-trip gain is greater than one. This lasing mode will exit via the OC coating on the gain medium and/or through the zero-order diffraction from the diffraction grating.

The coatings on both sides of each of the gain mediums 302, 402 further facilitates obtaining a laser output at a pre-selected wavelength. For example, an AR coating prevents undesirable reflections from forming, since undesirable reflections within the laser cavity can affect the final wavelength. Conversely, when reflections are desired, then a HR coating is provided to maximize reflections. To a certain extent, a light incident at a transparent interface between two materials will form a transmissive component and a reflective component. Hence, when there are light beams traveling through a multitude of materials and light beams traveling in both directions due to a feedback loop, care must be taken to minimize undesirable beam components from forming and propagating within the laser cavity.

It is contemplated that additional optical elements may be included in the cavities 300 or 400. For example, another wavelength converter may be included at the laser output. As another example, laser light energy regulators or switches may be included in the cavity. In any case, the laser cavities 300 or 400 could be packaged as a unit as is.

In other embodiments, the optical element 100 can be modified while still functioning as an integrated grating feedback and retro-reflector. As a first example, the optical element 100 can be asymmetrical in design. The faces 103, 205 of the bottom portion 102 need not be trapezoidal shapes. They can be of other quadrilateral shapes. As a second example, each of the angles s, 112 (see FIG. 1) need not be at the Brewster's angle or even at the same angles with respect to each other. However, if not at Brewster's angles, the first and second sides 106, 110 should be AR coated to prevent reflections from forming and such reflections (or subsequent beam components produced by the reflections) from possibly entering the gain medium.

As a third example, the top portion 104 can be a cylindrical lens cat's eye prism, a flat surface, a corner-cube, or other shapes as long as it is capable of reflecting the first order diffraction component along at least a substantially parallel beam path relative to the input beam path and can be fabricated from a single block of material along with the bottom portion 102. The roof prism (also referred to as a retroprism), cylindrical lens cat's eye prism, and flat surface retro-reflectors are examples of planar retro-reflectors (e.g., retro-reflects in the y-z plane as shown in FIG. 1). The corner-cube retro-reflector is an example of a spatial retro-reflector (e.g., retro-reflects in three-dimensional space). For these and possible other shaped retro-reflectors, it may be beneficial to provide a HR coating to maximize reflective properties.

As a fourth example, the input side of the optical element 100 (continuing the convention, the first side 106) can have a built-in collimating lens. This would eliminate the need to separately align a collimating lens relative to the gain medium and the optical element 100. The built-in collimating lens can be formed from the first side 106 having an appropriately curved surface, diffractive optic, etc.

As a fifth example, the optical element 100 may be tunable (to a certain extent) even after fabrication by temporarily inducing a change in the index of refraction of the optical element 100. The index of refraction of the optical element 100 can be slightly changed (in the range of ±0.01) by inducing an electro-optic effect (e.g., applying a certain voltage to the optical element 100), a thermo-optic effect (e.g., changing the temperature of the optical element 100), a stress-optic effect (e.g., applying pressure to the optical element 100 so as to induce stress to the optical element 100), etc. When the index of refraction n changes, the minimum-loss wavelength λ₀, changes (see Equation (1)) and the lasing mode wavelength changes, via the change in the round-trip phase induced by the different optical path length of the optical element 100. These changes may be synchronous in order to tune without mode hopping, or alternately not be synchronous in order to tune for short intervals in between mode hops.

As a sixth example, a monitor diode can be mounted to the second side 110. The monitor diode can be configured to act as a detector or sensor as to the operational state of the optical element 100.

As a seventh example, the optical element 100 may be fabricated from a semiconductor material. Two-photon absorption (a mechanism where photo carriers are generated in a material when two photons, each of which is not energetic enough to bridge the semiconductor's band gap, are absorbed simultaneously) provided by the semiconductor material allows the optical element 100 to function as a laser power monitor, as well as a “filter.”

As an eighth example, the bottom portion 102 and the top portion 104 may comprise different materials. In this instance, coating(s) may be required to prevent undesirable beam components (possibly at the interface between the two materials).

In an alternate embodiment where the top portion 104 is a flat or planar reflective surface (also referred to a flat or planar mirror), a thickness b of an optical element 500 is chosen so that the region between a diffraction grating 506 and a flat mirror 502 is operable as a “light pipe” (see FIG. 5A). The thickness b is selected such that light beams are guided within the optical element 500 with a minimum loss of intensity and without uncontrolled reflections from faces 508 and 510 (e.g., the boundary walls of the light pipe). The optical element 500 also includes a HR coating at the flat mirror 502.

Referring to FIG. 5A, the optical element 500 having a desirable thickness b is illustrated. The thickness b is selected such that light beams 512 and 514, illustrated as intensity profiles associated with plane wave fronts, propagate and are confined within the optical element 500 with minimum loss of intensity. The light beam or pulse 512 is traveling from the diffraction grating 506 toward the flat mirror 502. The light beam or pulse 514 is traveling from the flat mirror 502 toward the diffraction grating 506. The thickness b is selected to be substantially at the dimension where the intensity of a light pulse (to propagate within the optical element 500) having a substantially Gaussian intensity profile is at the 1/e² level (e.g., intensity profile 516) at the faces 508, 510.

FIGS. 5B and SC illustrate cases where the thickness b is not optimal. In FIG. 5C, the thickness b is too small, causing losses at faces 522 and 524 of a flat mirror optical element 520. An intensity profile 526 shows the intensity level to be substantially above the 1/e² level at the faces 522, 524. Conversely in FIG. 5C, the thickness b is too large for a flat mirror optical element 530. The optical element 530 does not provide sufficient confinement of the light beams, causing undesirable reflections at faces 532, 534. An intensity profile 536 is well below the 1/e² level at the faces 532, 534.

An optical element having a flat mirror with a desirable thickness b, such as shown in FIG. 5A, exhibits similar operating characteristics, e.g., misalignment insensitivity, as discussed above for the optical element 100. For optical elements such as those having a roof prism, e.g., the optical element 100, there is greater flexibility in selection of the thickness b.

Referring to FIG. 6, one embodiment of a fabrication technique of the optical element 500 is shown. The fabrication technique includes a starting material shaped and polished block 600, a form diffraction grating block 602, a provide coating(s) block 604, a cut into individual optical elements block 606, and a polish and finish optical elements block 608. The fabrication technique will be discussed with reference to FIGS. 7-11.

At the starting material shaped and polished block 600, a starting block or slab of the desired material is shaped into a trapezoidal “bar” 700 (FIG. 7). The bar 700 includes a top surface 702 and a bottom surface 704. The bar 700 has the height h and the top surface 702 has the length l. The bar 700 is configured to the dimensions required by Equations (1)-(4). The surfaces of the bar 700 are optically polished.

Next, at the form diffraction grating block 602, a diffraction grating 800 is formed at the bottom surface 704 (FIG. 8). The diffraction grating 800 may be formed using electron beam, photolithographic, or holographic techniques.

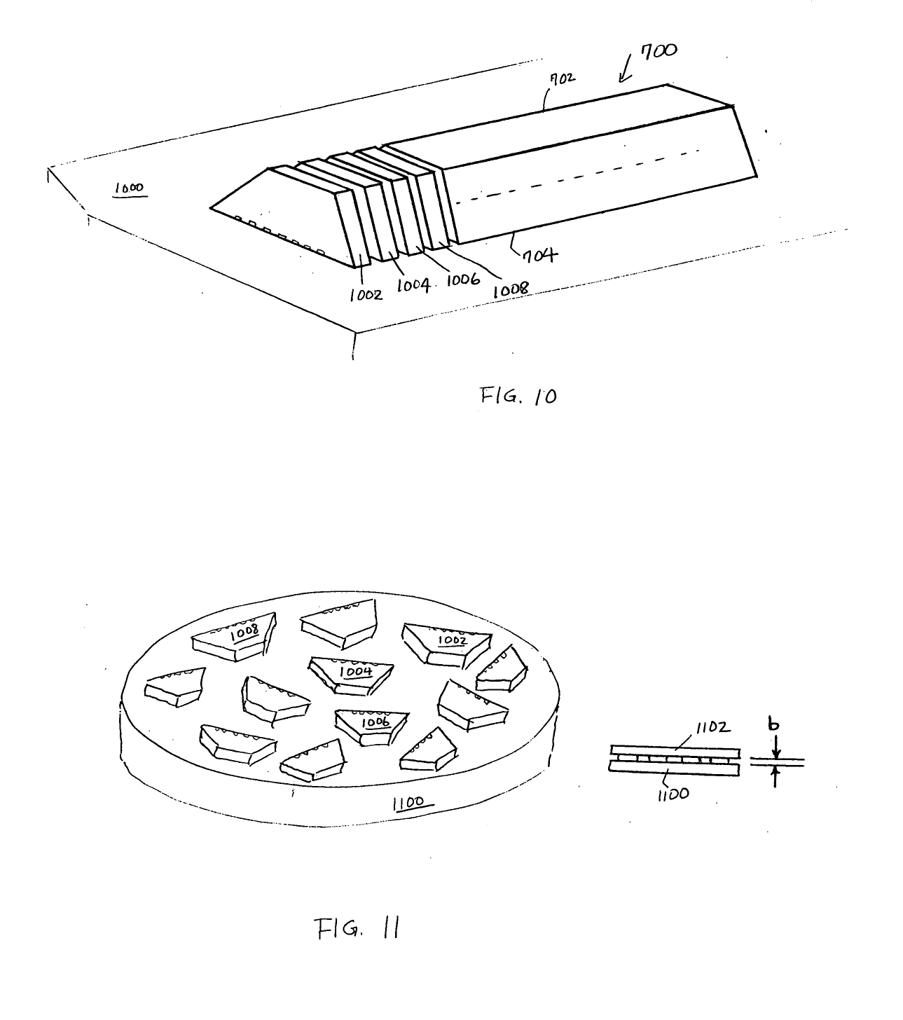

After the diffraction grating 800 has been formed, coating(s) are deposited on the bar 700 in the provide coating(s) block 604. In FIG. 9, at least an HR coating 900 is provided over the top surface 702. The HR coating 900 may comprise one or more metallic or dielectric materials. Although not shown, additional coatings may be provided on the bar 700. For example, a coating may be provided over the diffraction grating 800.

Next, at the cut into individual optical elements block 606, the bar 700 is cut into individual optical elements (e.g., optical elements 1002, 1004, 1006, 1008) (FIG. 10). Prior to cutting, the bar 700 can be coated with a protective layer (such as photo-resist) to minimize damage from the cutting tool or process. Prior to cutting, the bar 700 can also be temporarily attached to a stabilizing object, such as a substrate 1000. Each of the optical elements is cut to a thickness slightly larger than the desired thickness b.

At the polish and finish optical elements block 608, the individually cut optical elements are placed between two polishing plates 1100, 1102 in FIG. 11. The polishing plates 1100, 1102 are operable to simultaneously polish both faces of each of the optical elements and/or to finely grind the optical elements to the desired thickness b.

It is contemplated that there may be additional fabrication steps than discussed above. For example, after the polish and finish block 608, coatings or minor dimension adjustments may be made to one or more of the optical elements. As another example, the thickness of all the optical elements need not be the same in the cutting block 606. Although the fabrication technique is discussed with respect to fabrication of symmetrical optical elements having flat mirrors, the technique also applies for fabrication of optical elements having top portion 104 of different shapes (e.g., cylindrical lens cat's eye prism, roof prism, corner-cube, etc.) and/or non-symmetric design. The optical element 100 can be similarly fabricated. In certain instances, optical elements may be individually fabricated, rather than starting as many unfinished optical elements in the bar 700.

In this manner, a combined grating feedback and retroprism optical element is disclosed herein. A single optical element provides dispersion, outputs a first order diffraction component to form optical feedback, and outputs a zero order diffraction component. The single optical element also inherently provides alignment between its different “subcomponents” due to its monolithic design. (In other words, the retroprism and grating “subcomponents” are pre-aligned by the manufacturer by virtue of the unitary optical element design.) The single optical element provides two pre-selected outputs at opposite sides that do not interfere with each other, which permits single or dual ended cavity configurations with the same optical element. Even after fabrication, the single optical element can be further and/or optionally tuned within a certain wavelength range.

When the input and output surfaces of the optical element are at the Brewster's angles, no coating or other subcomponents are required since no reflections are formed at the input and output surfaces. This simplifies the fabrication process, and decreases costs. The monolithic design also simplifies and/or eliminates a lengthy alignment process. There is no need to critically align the diffraction grating and retro-reflective element(s) relative to each other, or align the grating and retro-reflective element(s) relative to the gain medium. Instead, the manufacturer (or user if the optical element is purchased separately) need only place the monolithic optical element in the path of a gain medium's output. Lastly, due to the pre-selective wavelength feature, an optical element can be particularly designed to output a desired wavelength.

While the invention has been described in terms of particular embodiments and illustrated figures, those of ordinary skill in the art will recognize that the invention is not limited to the embodiments or figures described. One or more aspects of one or more embodiments may be combined to form additional embodiments. The figures provided are merely representational and may not be drawn to scale. Certain proportions thereof may be exaggerated, while others may be minimized. The figures are intended to illustrate various implementations of the invention that can be understood and appropriately carried out by those of ordinary skill in the art. Therefore, it should be understood that the invention can be practiced with modification and alteration within the spirit and scope of the appended claims. The description is not intended to be exhaustive or to limit the invention to the precise form disclosed. It should be understood that the invention could be practiced with modification and alteration. From the foregoing, it will be appreciated that specific embodiments of the invention have been described herein for purposes of illustration, but that various modifications may be made without deviating from the spirit and scope of the invention. Accordingly, the invention is not limited except as by the appended claims and equivalents thereof.

What is claimed is:

1. A monolithic optical element, comprising:
a diffraction grating;
a reflecting surface disposed opposite the diffraction grating;
a first light transmissive surface disposed adjacent to the diffraction grating;
wherein the first light transmissive surface is operable to direct external light incident thereon from a first direction, internally toward the diffraction grating;
wherein the diffraction grating is operable to generate a first component of the directed light and internally direct the first component toward the reflecting surface;
wherein the reflecting surface is operable to reflect the first component internally toward the diffraction grating;
wherein the diffraction grating is operable to direct the reflected first component internally toward the first light transmissive surface; and
wherein the first light transmissive surface is operable to direct at least a portion of the reflected first component in a direction substantially opposite to the first direction and external to the monolithic optical element.

2. The monolithic optical element of claim 1, further comprising:
a second light transmissive surface disposed adjacent to the diffraction grating and opposite to the first light transmissive surface;
wherein the diffraction grating is operable to generate a second component of the directed light and internally direct the second component toward the second light transmissive surface; and
wherein the second light transmissive surface is operable to direct at least a portion of the directed second component external to the monolithic optical element.

3. The monolithic optical element of claim 2, wherein the second light transmissive surface is inclined at a Brewster's angle with respect to a plane of the diffraction grating.

4. The monolithic optical element of claim 2, wherein the second component is a zero order spectral diffraction component of the directed light.

5. The monolithic optical element of claim 1, wherein the first component is a first order spectral diffraction component of the directed light.

6. The monolithic optical element of claim 1, wherein the reflecting surface comprises a roof prism.

7. The monolithic optical element of claim 1, wherein the reflecting surface comprises a planar surface oriented parallel to a plane of the diffraction grating.

8. The monolithic optical element of claim 1, wherein the reflecting surface comprises a cylindrical lens cat's eye prism.

9. The monolithic optical element of claim 1, wherein the reflecting surface comprises a corner-cube retro-reflector.

10. The monolithic optical element of claim 1, wherein the reflecting surface comprises at least one of a planar retro-reflector and a spatial retro-reflector.

11. The monolithic optical element of claim 1, wherein the reflecting surface comprises a planar surface oriented parallel to a plane of the diffraction grating, and a thickness of the monolithic optical element is selected to confine at least one of the first component and the reflected first component within the monolithic optical element with minimum intensity loss.

12. The monolithic optical element of claim 1, wherein the first light transmissive surface is inclined at a Brewster's angle with respect to a plane of the diffraction grating.

13. The monolithic optical element of claim 1, wherein the reflected first component propagates internally along at least a substantially parallel beam path and in an opposite direction to the directed light and the first component.

14. The monolithic optical element of claim 1, wherein the external light is incident at the first light transmissive surface from the first direction at substantially parallel to a plane of the diffraction grating.

15. The monolithic optical element of claim 1, wherein a wavelength λ₀ of a light outputted from the monolithic optical element substantially parallel to the directed light is a function of an index of refraction n of the monolithic optical element.

16. The monolithic optical element of claim 15, wherein a periodic distance d associated with the diffraction grating is determined by:
$$d = {λ}_{0} ( \frac{{n}^{2} + 1}{2 {n}^{2}} ) .$$

17. The monolithic optical element of claim 15, wherein an inclination angle s of the first light transmissive surface with a plane of the diffraction grating is determined by:
$$s = {tan}^{- 1} ( \frac{1}{n} ) .$$

18. The monolithic optical element of claim 15, wherein a height h of the monolithic optical element is determined by:
$$h = \frac{1}{2} ( a + \frac{b}{2} ) ( {n}^{2} + 1 ) ,$$
where a is a maximum incidence distance of the directed light at the first light transmissive surface and b is a depth of the monolithic optical element.

19. The monolithic optical element of claim 15, wherein a length 1 of the reflecting surface is determined by:
$$l = an ( \frac{{n}^{2} + 1}{{n}^{2} - 1} ) ,$$
where a is a maximum incidence distance of the directed light at the first light transmissive surface.

20. A monolithic optical element, comprising:
a diffraction grating;
a first light transmissive surface disposed adjacent to the diffraction grating;
a second light transmissive surface disposed adjacent to the diffraction grating and opposite to the first light transmissive surface;
wherein the first light transmissive surface is operable to direct external light incident thereon from a first direction, internally toward the diffraction grating;
wherein the diffraction grating is operable to generate a first component of the directed light and internally direct the first component toward the second light transmissive surface; and
wherein the second light transmissive surface is operable to direct at least a portion of the first component in substantially a same direction as the first direction and external to the monolithic optical element.

21. The monolithic optical element of claim 20, further comprising:
a reflecting surface disposed opposite to the diffraction grating;
wherein the diffraction grating is operable to generate a second component of the directed light and internally direct the second component toward the reflecting surface;
wherein the reflecting surface is operable to reflect the second component internally toward the diffraction grating;
wherein the diffraction grating and the first light transmissive surface are operable to direct the reflected second component in a direction substantially opposite to the first direction and external to the monolithic optical element; and
wherein a feedback light is formed by the reflected second component and the directed light.

22. The monolithic optical element of claim 21, wherein the first component is a zero order diffraction component of the directed light and the second component is a first order diffraction component of the directed light.

23. The monolithic optical element of claim 21, wherein a desired wavelength of the feedback light and an index of refraction of the monolithic optical element determine geometry of the monolithic optical element.

24. The monolithic optical element of claim 21, wherein a wavelength of at least the first and second components is changed by inducing an electro-optic effect, a thermo-optic effect, or a stress-optic effect on at least a portion of the monolithic optical element.

25. The monolithic optical element of claim 21, wherein the reflecting surface comprises at least one of a roof prism, a cylindrical lens cat's eye prism, a planar surface, and a corner-cube retro-reflector.

26. The monolithic optical element of claim 21, wherein the reflecting surface comprises at least one of a planar retro-reflector and a spatial retro-reflector.

27. An extended cavity laser system, comprising:
a gain medium outputting a light beam;
a unitary optical element disposed adjacent to the gain medium, the unitary optical element including:
a diffraction grating;
a reflecting surface disposed opposite to the diffraction grating;
a first light transmissive surface disposed adjacent to the diffraction grating;
a second light transmissive surface disposed adjacent to the diffraction grating and opposite to the first light transmissive surface;
wherein the first light transmissive surface is operable to accept the light beam and internally direct the accepted light beam toward the diffraction grating;
wherein the diffraction grating is operable to generate a first component of the accepted light beam and internally direct the first component toward the reflecting surface, and generate a second component of the accepted light beam and internally direct the second component toward the second light transmissive surface;
wherein the reflecting surface is operable to reflect the first component internally toward the diffraction grating;
wherein the diffraction grating is operable to direct the reflected first component internally toward the first light transmissive surface;
wherein the first light transmissive surface is operable to direct the reflected first component external to the unitary optical element and toward the gain medium;
wherein the second light transmissive surface is operable to direct the second component external to the unitary optical element;
wherein a feedback light is formed from the reflected first component directed toward the gain medium and the light beam; and
wherein a laser output of the system is at least one of the second component and the feedback light.

28. The laser system of claim 27, wherein the laser system is operable as a single-ended extended laser cavity, the laser output is the second component, and the second component is a zero order diffraction component of the light beam.

29. The laser system of claim 27, wherein the laser system is operable as a dual-ended extended laser cavity, the laser output is the feedback light, and the first component is a first order diffraction component of the light beam.

30. The laser system of claim 27, wherein the gain medium establishes a new oscillation pattern, different from an oscillation pattern that would exist without the unitary optical element.

31. The laser system of claim 27, wherein the wavelength of the laser output is a function of an index of refraction of the unitary optical element.

32. The laser system of claim 27, wherein the unitary optical element is operable to provide light confinement with minimal intensity loss based on a thickness of the unitary optical element.

33. The laser system of claim 32, wherein the reflecting surface comprises a planar retro-reflector or a spatial retro-reflector.
